(19) United States
(12) Patent Application Publication
(10) Pub. No.: US 2025/0044573 A1
(43) Pub. Date: Feb. 6, 2025

(54) AREA SPECIFIC COLOR ABSORPTION IN NANOIMPRINT LITHOGRAPHY

(71) Applicant: Magic Leap, Inc., Plantation, FL (US)

(72) Inventors: Vikramjit Singh, Pflugerville, TX (US); Matthew C. Traub, Plantation, FL (US); Frank Y. Xu, Austin, TX (US)

(21) Appl. No.: 18/717,946

(22) PCT Filed: Dec. 16, 2022
(86) PCT No.: PCT/US2022/053238

§ 371 Date: Jun. 7, 2024

Related U.S. Application Data
(60) Provisional application No. 63/291,257, filed on Dec. 17, 2021.

(51) Int. Cl. G02B 25/00; G02B 1/118; G02B 5/22; G02B 27/00

(52) U.S. Cl. CPC G02B 25/001; G02B 1/118; G02B 5/22; G02B 27/0081

(57) ABSTRACT

An eyepiece includes an optical waveguide, a transmissive input coupler at a first end of the optical waveguide, an output coupler at a second end of the optical waveguide, and a polymeric color absorbing region along a portion of the optical waveguide between the transmissive input coupler and the output coupler. The transmissive input coupler is configured to couple incident visible light to the optical waveguide, and the color-absorbing region is configured to absorb a component of the visible light as the visible light propagates through the optical waveguide.

### CROSS-REFERENCE TO RELATED APPLICATION

This application claims the benefit of U.S. Patent Application No. 63/291,257 filed on Dec. 17, 2021, which is incorporated by reference herein in its entirety.

### TECHNICAL FIELD

This invention relates to techniques of fabricating area specific color-absorbing imprintable layers using inkjet based dye or pigment nanoimprint lithography over various substrates, as well as systems fabricated thereby.

### BACKGROUND

Optical imaging systems, such as head mounted display devices, can include eyepieces that present projected images to a user. Eyepieces can be constructed using thin layers of one or more highly refractive materials. As examples, eyepieces can be constructed from one or more layers of highly refractive glass, silicon, metal, or polymer substrates.

In some cases, an eyepiece can be patterned (e.g., with one or more light diffractive structures), such that it projects an image according to a particular focal depth. For an example, to a user viewing a patterned eyepiece, the projected image can appear to be a particular distance away from the user.

Further, multiple eyepieces can be used in conjunction to project a simulated three-dimensional image. For example, multiple eyepieces can be layered one atop another, with each eyepiece having a different pattern and each eyepiece projecting a different depth layer of a volumetric image. Thus, the eyepieces can collectively present the volumetric image to the user across three-dimensions. This can be useful, for example, in presenting the user with a “virtual reality” or “augmented reality” environment.

### SUMMARY

This disclosure describes techniques of fabricating area specific color-absorbing imprintable layers using inkjet based dye or pigment nanoimprint lithography over various substrates, as well as systems fabricated thereby. Some embodiments include area specific color-absorbing imprintable film with precise control on film thickness variation using inkjet based dye or pigment nanoimprint lithography over rigid or flexible substrates.

One or more of the described implementations can be used to produce imprint based patterning to absorb and make selective wavelengths of light propagate through or within (i.e., total internal reflection, or TIR) a substrate (e.g., glass or polymer). Such technology can make the waveguide stack architecture more flexible to designs, for example, in the use of inline single pupil input coupling gratings (ICGs) or split pupil ICGs where pupil positioning can overlap fully or partially over different substrates in the stack. This allows absorption of stray light entering a specific color waveguide where it does not propagate through and cause undesirable optical image quality. Inkjetting precise volumes and ultraviolet (UV) curing them with or without contact with superstrate allows for control over the shape and size of the film being cured, while having control on the thickness variation of the film. A controlled thickness variation tapering can have a desirable effect by reducing any unwanted phase tear of light propagating into the combined pupil expander (CPE) from the input coupler (IC).

Although the disclosed inventive concepts include those defined in the attached claims, it should be understood that the inventive concepts can also be defined in accordance with the following embodiments.

In addition to the embodiments of the attached claims and the embodiments described above, the following numbered embodiments are also innovative.

Embodiment 1 is an eyepiece comprising:
an optical waveguide;
a transmissive input coupler at a first end of the optical waveguide;
an output coupler at a second end of the optical waveguide; and
a polymeric color-absorbing region along a portion of the optical waveguide between the transmissive input coupler and the output coupler, wherein the transmissive input coupler is configured to couple incident visible light to the optical waveguide, and the color-absorbing region is configured to absorb a component of the visible light as the visible light propagates through the optical waveguide.

Embodiment 2 is an eyepiece of embodiment 1, wherein an exterior surface of the color-absorbing region defines features comprising protrusions, recessions, or both.

Embodiment 3 is an eyepiece of embodiment 2, wherein the features are nanofeatures.

Embodiment 4 is an eyepiece of embodiment 2 or 3, wherein the features define a pattern.

Embodiment 5 is an eyepiece of embodiment 4, wherein the pattern is a grating.

Embodiment 6 is an eyepiece of any one of embodiments 2 through 5, wherein the features comprise nanopillars.

Embodiment 7 is an eyepiece of any one of embodiments 2 through 6, wherein the features comprise cylindrical recessions.

Embodiment 8 is an eyepiece of any one of embodiments 1 through 7, wherein an exterior surface of the color-absorbing region is convex.

Embodiment 9 is an eyepiece of any one of embodiments 1 through 8, wherein an exterior surface of the color-absorbing region is planar.

Embodiment 10 is an eyepiece of embodiment 9, wherein a thickness of the color-absorbing region increases linearly from a first region to a second region.

Embodiment 11 is an eyepiece of any one of embodiments 1 through 10, wherein the polymeric color-absorbing region is in direct contact with the portion of the waveguide.

Embodiment 12 is an eyepiece of any one of embodiments 1 through 11, further comprising a polymeric antireflective layer opposite the input coupler.

Embodiment 13 is an eyepiece of embodiment 12, wherein the polymeric antireflective layer comprises nanopatterned features on an exterior of the optical waveguide.

Embodiment 14 is an eyepiece of embodiment 12 or 13, wherein the polymeric antireflective layer is configured to absorb the one or more components of visible light transmitted through the waveguide from the input coupler to the antireflective layer.

Embodiment 15 is an eyepiece of any one of embodiments 1 through 14, wherein the optical waveguide is configured to totally reflect the visible light as the visible light propagates through the optical waveguide.

Embodiment 16 is an eyepiece of any one of embodiments 1 through 15, wherein the component of visible light comprises one or more of red light, green light, and blue light.

Embodiment 17 is an eyepiece of any one of embodiments 1 through 16, wherein the component of visible light comprises red light and green light, and blue light that propagates through the optical waveguide exits the optical waveguide through the output coupler.

Embodiment 18 is an eyepiece of any one of embodiments 1 through 17, wherein the transmissive input coupler is an inline input coupler.

Embodiment 19 is an eyepiece of any one of embodiments 1 through 18, wherein the output coupler is a combined pupil expander.

Embodiment 20 is an eyepiece of any one of embodiments 1 through 19, further comprising an additional optical waveguide optically coupled to the optical waveguide.

Embodiment 21 is an eyepiece of embodiment 20, wherein the eyepiece defines a gap between the optical waveguide and the additional optical waveguide.

Embodiment 22 is an eyepiece of embodiment 20 or 21, wherein the eyepiece comprises an additional transmissive input coupler at a first end of the additional optical waveguide and an additional output coupler at a second end of the additional optical waveguide.

Embodiment 23 is an eyepiece of any one of embodiments 20 through 22, wherein the eyepiece comprises an additional reflective input coupler at a first end of the additional optical waveguide and an additional output coupler at a second end of the additional waveguide.

Embodiment 24 is an eyepiece of embodiment 22 or 23, wherein the additional input coupler is configured to couple visible light that passes through the antireflective layer to the additional optical waveguide.

Embodiment 25 is an eyepiece of any one of embodiments 22 through 24, further comprising an additional polymeric color-absorbing region along a portion of the additional waveguide between the additional transmissive input coupler and the additional output coupler, wherein the additional transmissive input coupler is configured to couple visible light that passes through the antireflective layer to the additional optical waveguide, and the additional color-absorbing region is configured to absorb an additional component of visible light as the visible light propagates through the optical waveguide.

Embodiment 26 is an eyepiece of embodiment 25, wherein the additional component of the visible light comprises at least one of red, green, and blue.

Embodiment 27 is an eyepiece of embodiment 26, wherein at least one of the additional components of visible light differs from at least one of the components of visible light.

Embodiment 28 is an eyepiece comprising:
an optical waveguide;
a reflective input coupler at a first end of the waveguide;
a first polymeric antireflective layer proximate the reflective input coupler;
an output coupler at a second end of the waveguide; and
a second polymeric antireflective layer opposite the input coupler, wherein a portion of the second antireflective layer comprises a color filter, the color filter is configured to filter a component of visible light incident on the second antireflective layer, and the first antireflective layer is configured to transmit the component of visible light.

Embodiment 29 is an eyepiece of embodiment 28, wherein the component of visible light comprises one or more of red light, green light, and blue light.

Embodiment 30 is an eyepiece of embodiment 29, wherein an additional component of the incident visible light propagates through the optical waveguide toward the output coupler.

Embodiment 31 is an eyepiece of embodiment 30, wherein the additional component of the incident visible light comprises one or more of red light, green light, and blue light, and the additional component of the incident visible light differs from the component of visible light.

Embodiment 32 is an eyepiece of any one of embodiments 28 through 31, further comprising an additional optical waveguide optically coupled to the optical waveguide.

Embodiment 33 is an eyepiece of embodiment 32, wherein the eyepiece defines a gap between the optical waveguide and the additional optical waveguide.

Embodiment 34 is an eyepiece comprising:
an optical waveguide;
a two-sided input coupler at a first end of the waveguide, wherein a first side of the two-sided input coupler is opposite a second side of the two-sided coupler, the first side of the two-sided input coupler operates in transmissive mode, and the second side of the two-sided input coupler operates in transmissive mode or reflective mode; an output coupler; and
a polymeric color-absorbing region along a portion of the waveguide between the two-sided input coupler and the output coupler, wherein the first side of the two-sided input coupler is configured to couple incident visible light to the waveguide, and the color-absorbing region is configured to absorb a first component of visible light and transmit a second component of the visible light as the visible light propagates through the optical waveguide, wherein the first component and the second component are different.

Embodiment 35 is an eyepiece of embodiment 34, wherein the second side of the two-sided input coupler is configured to transmit the first component of the visible light and reflect the second component of the visible light.

Embodiment 36 is an eyepiece of embodiment 34 or 35, further comprising patterned polymeric features in direct contact with the optical waveguide and between the optical waveguide and the polymeric color-absorbing region.

Embodiment 37 is an eyepiece of any one of embodiments 34 through 36, further comprising an additional optical waveguide optically coupled to the optical waveguide.

Embodiment 38 is an eyepiece of embodiment 37, wherein the eyepiece defines a gap between the optical waveguide and the additional optical waveguide.

Embodiment 39 is an eyepiece of embodiment 37 or 38, wherein the additional optical waveguide is configured to absorb an additional component of the visible light, and the component of visible light differs from the additional component of visible light.

Embodiment 40 is a method of forming a coating on a portion of a waveguide, the method comprising:
disposing a colored polymerizable material on the portion of the waveguide, wherein a color of the colored polymerizable material is selected to absorb or transmit a selected color of visible light;
contacting the colored polymerizable material with a template; and
curing the colored polymerizable material to yield a colored film on the portion of the waveguide.

Embodiment 41 is a method of embodiment 40, wherein the portion of the waveguide comprises at least a portion of an anti-reflective layer, a portion of an input coupler, a portion of an output coupler, or a portion of a length of the waveguide between the input coupler and the output coupler.

Embodiment 42 is a method of embodiment 40 or 41, wherein the colored polymerizable material is selected to absorb or transmit one or more of red light, green light, and blue light.

Embodiment 43 is a method of any one of embodiments 40 through 42, wherein the template is patterned.

Embodiment 44 is a method of embodiment 43, wherein the patterned template comprises protrusions and recessions.

Embodiment 45 is a method of embodiment 44, wherein a dimension of the protrusions and recessions and a distance between two of the protrusions or a distance between two of the recessions is in a range between 10 nanometers and 500 nanometers.

Embodiment 46 is a method of any one of embodiments 40 through 45, wherein a thickness of the colored film is in a range between 100 nm and 2000 nm.

Embodiment 47 is an eyepiece comprising:
an optical waveguide;
a reflective input coupler at a first end of the optical waveguide;
an output coupler at a second end of the optical waveguide; and
a polymeric color-absorbing region along a portion of the optical waveguide between the reflective input coupler and the output coupler, wherein the reflective input coupler is configured to couple incident visible light to the optical waveguide, and the color-absorbing region is configured to absorb a component of the visible light as the visible light propagates through the optical waveguide.

Embodiment 48 is an eyepiece of embodiment 47, wherein an exterior surface of the color-absorbing region defines features comprising protrusions, recessions, or both.

Embodiment 49 is an eyepiece of embodiment 48, wherein the features are nanofeatures.

Embodiment 50 is an eyepiece of embodiment 48 or 49, wherein the features define a pattern.

Embodiment 51 is an eyepiece of embodiment 50, wherein the pattern is a grating.

Embodiment 52 is an eyepiece of any one of embodiments 48 through 51, wherein the features comprise nanopillars.

Embodiment 53 is an eyepiece of any one of embodiments 48 through 52, wherein the features comprise cylindrical recessions.

Embodiment 54 is an eyepiece of any one of embodiments 47 through 53, wherein an exterior surface of the color-absorbing region is convex.

Embodiment 55 is an eyepiece of any one of embodiments 47 through 54, wherein an exterior surface of the color-absorbing region is planar.

Embodiment 56 is an eyepiece of embodiment 55, wherein a thickness of the color-absorbing region increases linearly from a first region to a second region.

Embodiment 57 is an eyepiece of any one of embodiments 47 through 56, wherein the polymeric color-absorbing region is in direct contact with the portion of the waveguide.

Embodiment 58 is an eyepiece of any one of embodiments 47 through 57, further comprising a polymeric antireflective layer opposite the input coupler.

Embodiment 59 is an eyepiece of embodiment 58, wherein the polymeric antireflective layer comprises nanopatterned features on an exterior of the optical waveguide.

Embodiment 60 is an eyepiece of embodiments 58 or 59, wherein the polymeric antireflective layer is configured to absorb the one or more components of visible light transmitted through the waveguide from the input coupler to the antireflective layer.

Embodiment 61 is an eyepiece of any one of embodiments 47 through 60, wherein the optical waveguide is configured to totally reflect the visible light as the visible light propagates through the optical waveguide.

Embodiment 62 is an eyepiece of any one of embodiments 47 through 61, wherein the component of visible light comprises one or more of red light, green light, and blue light.

Embodiment 63 is an eyepiece of any one of embodiments 47 through 62, wherein the component of visible light comprises red light and green light, and blue light that propagates through the optical waveguide exits the optical waveguide through the output coupler.

Embodiment 64 is an eyepiece of any one of embodiments 47 through 63, wherein the reflective input coupler is an inline input coupler.

Embodiment 65 is an eyepiece of any one of embodiments 47 through 64, wherein the output coupler is a combined pupil expander.

Embodiment 66 is an eyepiece of any one of embodiments 47 through 65, further comprising an additional optical waveguide optically coupled to the optical waveguide.

Embodiment 67 is an eyepiece of embodiment 66, wherein the eyepiece defines a gap between the optical waveguide and the additional optical waveguide.

Embodiment 68 is an eyepiece of embodiment 66 or 67, wherein the eyepiece comprises an additional reflective input coupler at a first end of the additional waveguide and an additional output coupler at a second end of the additional waveguide.

Embodiment 69 is an eyepiece of any one of embodiments 66 through 68, wherein the eyepiece comprises an additional reflective input coupler at the first end of the additional waveguide and an additional output coupler at a second end of the additional waveguide.

Embodiment 70 is an eyepiece of embodiment 68 or 69, wherein the additional input coupler is configured to couple visible light that passes through the antireflective layer to the additional optical waveguide.

Embodiment 71 is an eyepiece of any one of embodiments 68 through 70, further comprising an additional polymeric color-absorbing region along a portion of the additional waveguide between the additional reflective input coupler and the additional output coupler, wherein the additional reflective input coupler is configured to couple visible light that passes through the antireflective layer to the additional optical waveguide, and the additional color-absorbing region is configured to absorb an additional component of visible light as the visible light propagates through the optical waveguide.

Embodiment 72 is an eyepiece of embodiment 71, wherein the additional component of the visible light comprises at least one of red, green and blue.

Embodiment 73 is an eyepiece of embodiment 72, wherein at least one of the additional components of visible light differs from at least one of the components of visible light.

The details of one or more embodiments are set forth in the accompanying drawings and the description below. Other features and advantages will be apparent from the description and drawings, and from the claims.

### BRIEF DESCRIPTION OF DRAWINGS

FIGS. 1A-1D depict various process components in ultraviolet (UV) based color-absorbing resin inkjetting and imprinting.

FIGS. 2A-2D depict inkjet drop dispense and spreading of color-absorbing resin on a substrate. FIGS. 2E-2G depict nanoimprinting processes to yield various cured color-absorbing resin structures. FIG. 2H depicts a cross section of a color-specific eyepiece waveguide with color-absorbing regions.

FIG. 3 illustrates a cross section of an eyepiece with four different locations where colored resin can be imprinted or applied with or without nanogeometry.

FIG. 4 depicts a cross section of an embodiment of a waveguide system with waveguides having a single inline input coupling grating (ICG) and color-absorbing regions.

FIG. 5 depicts a cross section of an embodiment of a waveguide system with waveguides having a single inline ICG, color-absorbing regions, and color-absorbing filters.

FIG. 6 depicts a cross section of an embodiment of a waveguide system with waveguides having a split pupil reflective ICG and color-absorbing filters.

FIG. 7 depicts a cross section of an embodiment of a waveguide system with a two-sided ICG and color-absorbing films.

FIG. 8 depicts a cross section of an embodiment of a waveguide system with a single inline ICG, imprinted output couplers (OC) and color-absorbing regions.

FIG. 9 shows transmittance of example dye or pigment sub-1 μm films over a control substrate.

FIGS. 10A and 10B show virtual images with a 70° field of view (FoV) from blue and red waveguide by incoupling all three colors and having blue and red color-absorbing regions outside the ICG towards the combined pupil expander (CPE).

FIGS. 11A and 11B show thickness of color-absorbing films applied to obtain the images in FIGS. 8A and 8B.

FIGS. 12A and 12B show examples of cured colored films made by changing concentration of dye or pigment. FIG. 12C shows transmittance of the color-absorbing films.

FIGS. 13A and 13B shows transmittance of patterned versus blank red color imprinted thin film, with very high transmission of red versus green and blue over a substrate.

FIG. 14 shows a template after imprinting a colored resist and blank and anti-reflective patterned red imprint resist shown over a glass wafer.

FIGS. 15A and 15B show example process embodiments of fabricating dispensed and cured film patches with control over film shape and thickness.

### DETAILED DESCRIPTION

Techniques for producing area specific color-absorbing imprintable layers using inkjet based dye or pigment nanoimprint lithography over various substrates are described, as well systems fabricated thereby.

In conventional systems, stack architecture does not typically have the capability of sustaining gap control for red-green-blue (RGB) waveguide stacks at a 2.3 μm/cm specification in order to maintain optical sharpness of virtual images when two or more light wavelengths are incoupled into the same waveguide meant for one color. This can happen due to a color's virtual output not aligning when it goes through two or more waveguide substrates, causing image ghosts. This can hamper future waveguide stack architecture design which can be simplified by incoupling two or more wavelengths into a single substrate (1.7n<2.7) in order to expand the horizontal and vertical field of view (FoV) and/or by partially or fully overlapping the projector pupil, the volume of the projector light engine can significantly reduce for a virtual reality (VR) or augmented reality (AF) headset. Without adequate gap control technology, waveguide architecture cannot typically reduce gap control sensitivity to the optical image quality while helping simplify the projector to waveguide integration.

Embodiments described in this disclosure combine use of UV resin inkjet and nanoimprinting (Jet and Flash Imprint Lithography, J-FIL™) with ultrafine control on thickness and ability to pattern features at the sub-5 nm scale with the ability to absorb specific wavelengths of light. These embodiments can reduce the wearable form factor of waveguides from a systems level (waveguide+projector layout) by giving the design more flexibility and freedom in terms of enabling inline single pupil ICGs. These embodiments can allow positioning of two or IC pupils closer to each other. This is can be achieved, for example, by having area or site-specific imprints with certain UV curable resins dispensed using on drop-on-demand technology via single or multipoint inkjet heads. Such resin films (e.g., dots, pads, patches, etc.) can have specific absorption for desired wavelengths of light, thereby reducing or preventing undesired light from propagating into (or through) the waveguide, thus becoming extinct before it affects the virtual image by out coupling towards the user. This precise area specific film patterning with nano scale control on the thickness of a blank or film with nano- or micro-features can be applied to any surface of a rigid or flexible substrate composed of inorganic materials, organic materials, metallic materials, or a combination thereof.

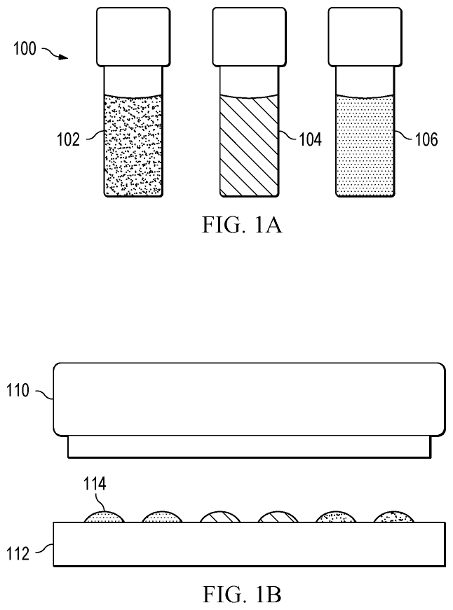

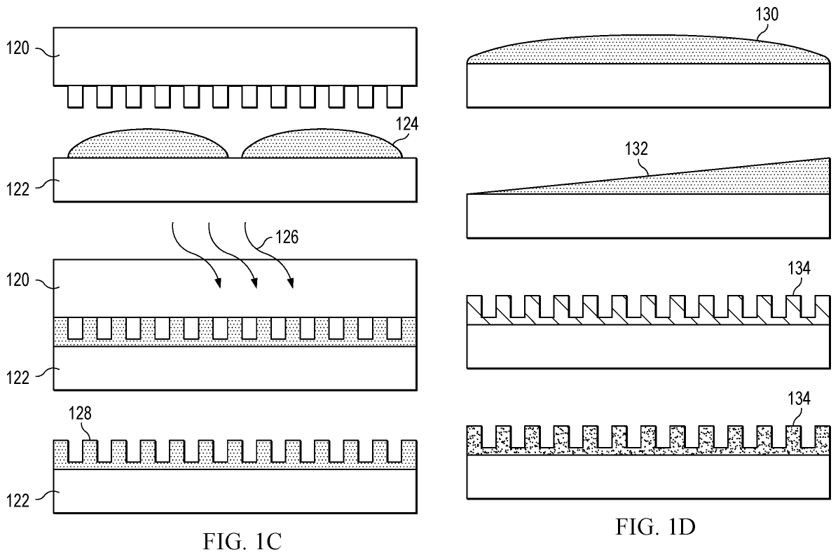

FIGS. 1A-1D depict various process components in UV based color-absorbing inkjetting and imprinting. As used herein, a “dispensed structure” refers to a cured color-absorbing structure formed without a patterned template, and a “patterned structure” refers to a cured color-absorbing structure formed with a patterned template.

FIG. 1A depicts UV based color-absorbing resins 100, including red 102, green 104, and blue 106 having a selected amount of dye or pigment in a UV curable resin. Suitable dyes and pigments include Rhodamine B, Tartarzine, chemical dyes from Yamada Chemical Co., Ltd., SUNFAST pigments from SunChemical (e.g., Green 36, Blue, Violet 23, etc.).

In some embodiments, the dye or pigment is combined with a solvent and then combined with a UV curable resin to yield a color-absorbing resin. The solvent can be a volatile solvent, such as an alcohol (methanol, ethanol, butanol, or the like) or other less volatile organic solvents, such as dimethylsulfoxide (DMSO), propylene glycol monomethyl ether acetate (PGMEA), toluene, and the like. The dye or pigment can be separated from the solvent or concentrated (e.g., using centrifuge evaporation) to yield an optimal concentration with the crosslinking organic resin (e.g., a UV curable highly transparent material). An optimal concentration of the dye or pigment can impart a color-absorbing film with desirable optical characteristics, such as a greater concentration of color-absorbing dye or pigment, and yield less reflective films.

FIG. 1B depicts inkjet head 110 above substrate 112, with drops 114 of various color-absorbing resins dispensed by inkjet head 110 onto substrate 112.

FIG. 1C depicts patterned template 120 positioned above substrate 122 with drops 124 of color-absorbing resin. Template 120 contacts color-absorbing resin 124, and color-absorbing resin 124 is cured with UV light 126 to yield patterned cured color-absorbing resin 128. Template 120 is separated from patterned cured color-absorbing resin 128 to leave patterned cured color-absorbing resin 128 on substrate 122.

FIG. 1D depicts cured color-absorbing resins of various configurations, including dispensed domed structure 130, dispensed wedged structure 132, and patterned grating structure 134. Color-absorbing structures 130, 132, 134 can be of any color, as determined by the dye present in the color-absorbing resin used to fabricate the structure.

The process of fabricating color-absorbing regions of a desired shape, thickness (or thickness variation) can be achieved with inkjet dispensing of a color-absorbing resin, followed by spreading of the color-absorbing resin on a substrate (e.g., a surface of a waveguide). As used herein, “color-absorbing” and “color-selective” generally refer to “wavelength-absorbing” and “wavelength-selective,” respectively, all of which terms are used interchangeably. During spreading, solvent present in the color-absorbing resin may evaporate. The color-absorbing resin is cured to yield a color-absorbing dispensed structure. In some cases, the color-absorbing resin is contacted with a patterned template with a selected micro- or nano-topography and micro- or nano-topography and then cured (e.g., by UV light) to yield a color-absorbing patterned structure. This process allows precise control over the shape and thickness of the cured dispensed or patterned structure. The configuration of the dispensed or patterned structure (i.e., the cured layer or film) can be designed to perform a selected optical function, such as diffractive outcoupling, increased surface to volume ratio for light absorption, and reduced surface reflection losses without introducing light scattering. Imprint geometry (anti-reflection geometry) can be imparted to colored UV curable resists and controlled by varying total thickness variation (TTV)/local thickness variation (LTV) to avoid phase tear of light propagating in the waveguide and diffractive geometry which can further outcouple unwanted light wavelengths.

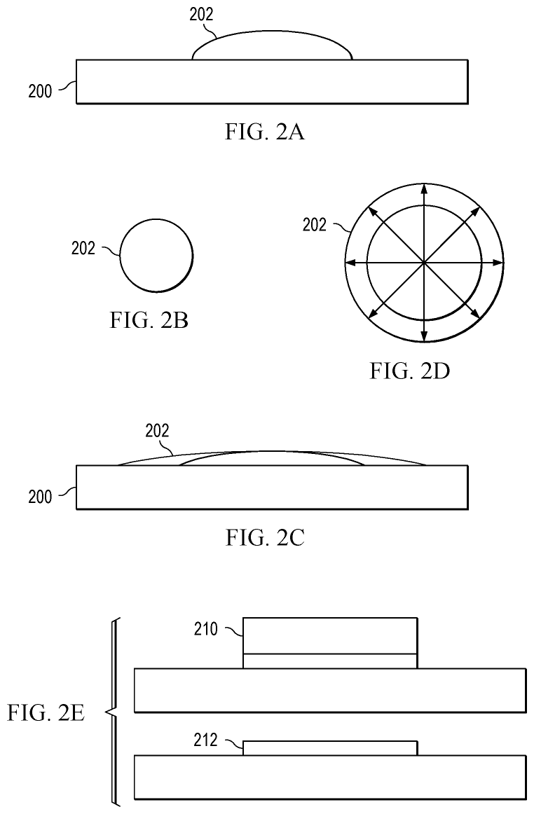

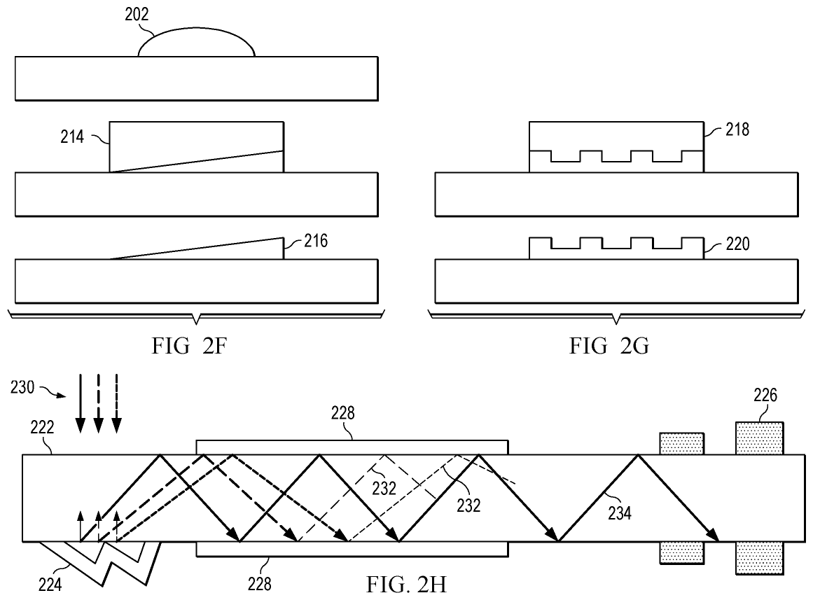

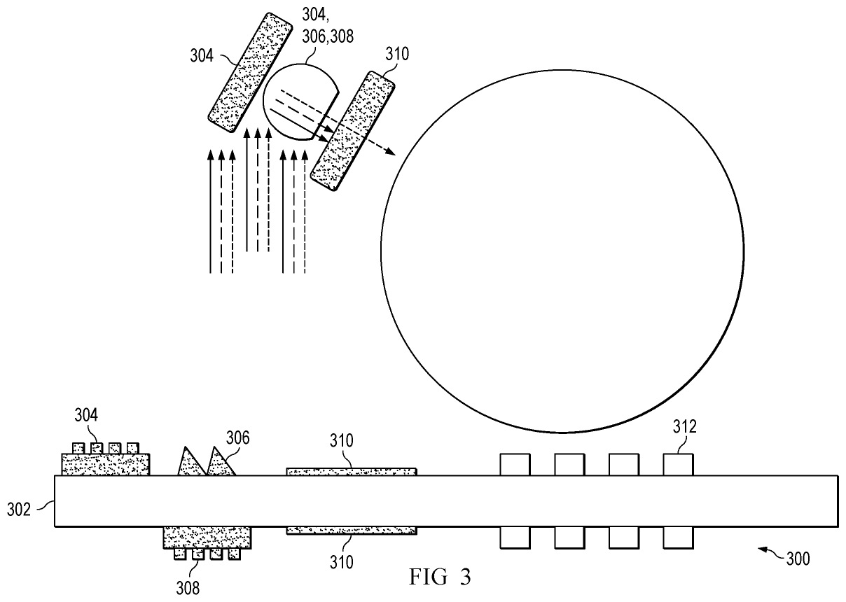

FIG. 2A is a side view of substrate 200 with drop 202 of color-absorbing resin on the surface of substrate 200. FIG. 2B is a top view of drop 202 as dispensed on substrate 200. FIG. 2C a side view of drop 202 on substrate 200 showing an increase in diameter as drop 202 spreads on substrate 200. FIG. 2D is a top view of drop 202 showing the increase in diameter of drop 202 during spreading.

FIGS. 2E-2G depict shaping of drop 202 as the color-absorbing resin is cured. In FIG. 2E, drop 202 is contacted with flat surface of template 210, and the color-absorbing resin is cured to leave thin film 212 of a uniform thickness having a selected shape, volume, area (e.g., covered surface area of substrate 210, or total surface area of thin film 212), and color. In FIG. 2F, drop 202 is contacted with angled surface of template 214, and the color-absorbing resin is cured to leave wedge-shaped structure 216 having a selected shape, volume, area (e.g., covered surface area of substrate 200, or total surface area of thin film wedge-shaped structure 216), and color. In FIG. 2G, drop 202 is contacted with patterned surface of template 218, and the color-absorbing resin is cured to leave patterned structure 220 with patterned features having selected size (e.g., height, depth, width), spacing, residual layer thickness, total surface area, and color.

FIG. 2H depicts an example of a waveguide 222 having reflective input coupling grating (ICG) 224, combined pupil expander (CPE) 226, and color-absorbing regions 228 on surface of waveguide 222 between ICG 223 and CPE 226. RGB light 230 enters waveguide 222 opposite ICG 224 and is totally internally reflected along a length of waveguide 222 between ICG 224 and CPE 226. Color-absorbing regions 228 absorb one or more wavelength regions (e.g., colors) 232 of RGB light 230, and allow one or more wavelength regions (e.g., colors) 234 of RGB light to exit waveguide 222 through CPE 226.

Color-absorbing cured resin (e.g., color specific absorption material) can be advantageous in a variety of locations on eyepiece waveguides. FIG. 3 depicts a cross section of eyepiece 300 showing four examples of locations where color-absorbing resin can be imprinted or applied along waveguide 302 with or without nanogeometry.

In one embodiment, OC 304 in the super pupil area not overlapping with IC 306 includes nanopatterned color-absorbing features configured to absorb stray light. In one example, a red OC absorbs green and blue stray light entering a red IC from illumination.

In some embodiments, IC 306 includes nanopatterned color-absorbing diffractive features. In one example, IC 306 is a red IC. The red IC diffracts less green and blue light than a non-colored IC with the same red pitch grating.

In some embodiments, anti-reflective region 308 behind IC 306 includes nanopatterned color-absorbing features. In one example, a red anti-reflective region absorbs green and blue light, reducing diffraction of green and blue light into the IC.

In some embodiments, color-absorbing region 310 along waveguide 302 between OC 304 and OC 306 includes dispensed or patterned color-absorbing regions to absorb light in TIR as it hits the colored film and glass interface in region 310. In one example, a red color-absorbing region absorbs diffracted green and blue light launching from a red IC.

Certain embodiments include two or more of the embodiments of color-absorbing dispensed or patterned features described with respect FIG. 3 (e.g., two or more of OC 304, IC 306, anti-reflective region 308, color-absorbing region 310, and combined pupil expander (CPE) 312). Other OC, such as exit pupil expander (EPE) and orthogonal pupil expander (OPE) can also include color-absorbing dispensed or patterned features.

In some embodiments, a first color-absorbing region 310 extends along a first side of waveguide 302, such that a first edge of first color-absorbing region 310 contacts IC 306 ICG and a second edge of first color-absorbing region 310 contacts CPE 312. A second color-absorbing region 310 can extend along a second side of waveguide 302, such that a first edge of second color-absorbing region 310 contacts reflective region 308 and a second edge of second color-absorbing region 310 contacts CPE 312. This configuration can help maintain bounce continuity for the light in total internal reflection (TIR), resulting in images outcoupled through CPE 312 towards the user which are sharper than a case in which a discontinuity exists as the light is in TIR propagating through the waveguide.

In some embodiments, edges of color-absorbing region 310 proximate IC 306, CPE 312, or both along the optical light path can be tapered (e.g., similar to tapering of wedge-shaped structure 216 in FIG. 2F). In some embodiments, color-absorbing region 310 has a thickness selected in a range of about 50 nm to about 500 nm to improve image sharpness. At least one lateral dimension of color-absorbing region 310 can be, for example, up to 30 mm. A thickness of the tapering can be about the same as a width of IC 306 along the optical axis. In one example, if the IC 306 is 1 mm wide along the light launch direction, then the tapering width can be spread over at least 1 mm.

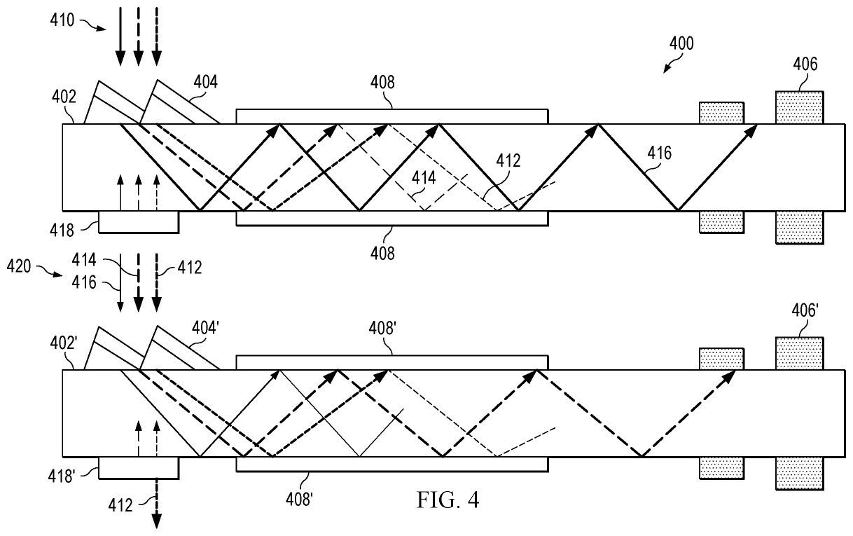

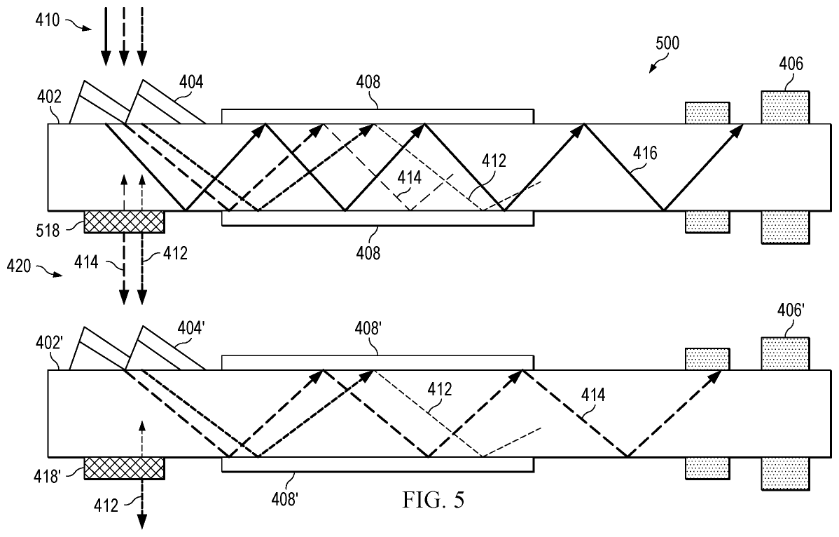

FIG. 4 depicts a cross section of eyepiece 400 with color-selective waveguides 402, 402′. Waveguide 402 has inline ICG 404 on the user side (one-side transmissive) and combined pupil expander (CPE) 406. Color-absorbing regions 408 between ICG 404 and CPE 406 on surfaces of waveguide 402 are thin films of dispensed or imprinted dye resin.

RGB light 410 enters waveguide 402 through ICG 404 and is totally reflected as it travels from ICG 404 to CPE 406 in waveguide 402. When waveguide 402 is a blue waveguide, regions 408 are formed of a dye resin that absorbs green and red light. Red light 412 and green light 414 are absorbed by regions 408 before the light outcouples, and light that is predominantly blue exits waveguide 402 through CPE 406. Red light 412, green light 414, and attenuated blue light 416 exit waveguide 402 through anti-reflective layer 418, travel through gap 420, and enter waveguide 402′ through ICG 404′. The air gap can be used to establish optical functionality of individual active layers handling one or more colors. In some cases, air gaps are between 20 μm and 100 μm. An air gap is also influenced by thickness of the waveguide stack and the focal distance of projector light into ICGs on the active layers.

Light that enters ICG 404′ is totally reflected as it travels from ICG 404′ to CPE 406′ through waveguide 402′. When waveguide 402′ is a green waveguide, regions 408′ are formed of a dye resin that absorbs red and blue light. Thus, red light 412 and blue light 414 are absorbed by regions 408′, and light that is predominantly green exits waveguide 402′ from CPE 406′. Red light 412, and attenuated green and blue light 414 and 416, if present, exit waveguide 402′ through anti-reflective layer 418′, which is not a color-absorbing layer. Light that exits waveguide 402′ through anti-reflective layer 418′ can travel through a second gap to a third waveguide (not shown) with regions that absorb green and blue light, such that light exiting the third waveguide through a third CPE is predominantly red.

The inset in FIG. 4 is an image of an eyepiece with color-selective waveguides.

FIGS. 5-8 depict additional embodiments of eyepieces with color-selective waveguides. The waveguide systems depicted in FIGS. 5-8 can be implemented without the gap control described with respect to FIG. 4.

FIG. 5 shows a cross section of eyepiece 500 with color-selective waveguides 402, 402′. Waveguide 402 has inline ICG 404 on the user side (one-side transmissive) and CPE 406. Color-absorbing regions 408 between ICG 404 and CPE 406 on surfaces of waveguide 402 are formed as a thin films of dispensed or imprinted dye resin.

RGB light 410 enters waveguide 402 through ICG 404 and is totally reflected as it travels from ICG 404 to CPE 406 in waveguide 402. When waveguide 402 is a blue waveguide, regions 408 are formed of a dye resin that absorbs green and red light. Red light 412 and green light 414 are absorbed by regions 408 before the light outcouples, and light that is predominantly blue exits waveguide 402 through CPE 406. Red light 412, green light 414, and attenuated blue light 416 exit waveguide 402 through color filter 518, travel through gap 420, and enter waveguide 402′ through ICG 404′. Color filter 518 is selected to absorb blue light 416 and transmit red light 412 and green light 414.

Light that enters ICG 404′ is totally reflected as it travels from ICG 404′ to CPE 406′ through waveguide 402′. When waveguide 402′ is a green waveguide, regions 408′ are formed of a dye resin that absorbs red and blue light. Thus, red light 412 and blue light 414 are absorbed by regions 408′, and light that is predominantly green exits waveguide 402′ from CPE 406′. Red light 412, attenuated green 414, and attenuated blue light 416, if present, exit waveguide 402′ through anti-reflective layer 418′. Light that exits waveguide 402′ through anti-reflective layer 418′ can travel through another gap to a third (red) waveguide (not shown) with regions that absorb green and blue light, such that light exiting the third waveguide through a third CPE is predominantly red.

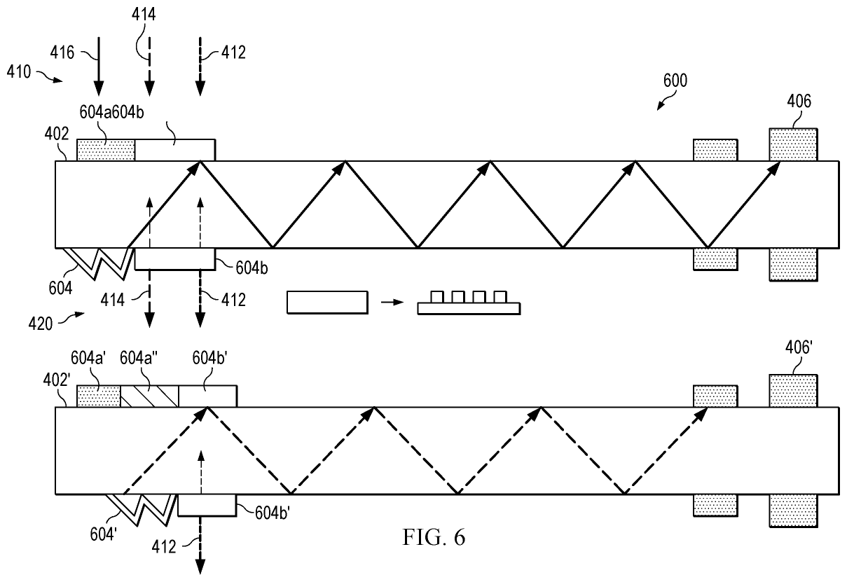

FIG. 6 shows a cross section of eyepiece 600 with color-selective waveguides 402, 402′. Waveguide 402 has split pupil reflective mode ICG 604. Color-absorbing anti-reflective filter 604a and anti-reflective layer 604b are on the user side of waveguide 402, with anti-reflective filter 604b opposite ICG 604.

RGB light 410 enters waveguide 402 through anti-reflective color filter 604a and anti-reflective layer 604b. When waveguide 402 is a blue waveguide, anti-reflective filter 604a is a blue anti-reflective filter. Red light 412 and green light 414 are absorbed by anti-reflective filter 604a. Light that is predominantly blue passes through anti-reflective filter 604a and is diffracted by ICG 604, totally reflected along a length of waveguide 402, and exits waveguide 402 through CPE 406. Red light 412, green light 414, and attenuated blue light 416, if present, exit waveguide 402 through anti-reflective layer 418, travel through gap 420, and enter waveguide 402′ through blue color-absorbing anti-reflective filter 604a′, green color-absorbing anti-reflective filter 604a″, and anti-reflective layer 604b′.

Red light 412 and green light 414 are absorbed by anti-reflective filter 604a′, and red light 412 and blue light 416 are absorbed by anti-reflective filter 604a″. Light that is predominantly green is diffracted by ICG 304′, totally reflected along a length of waveguide 402′, and exits waveguide 402′ through CPE 406′. Red light 412, attenuated green light 414, and attenuated blue light 416, if present, exit waveguide 402′ through anti-reflective layer 418′, and can travel through a second gap to a red waveguide (not shown) such that light exiting the third waveguide through a third CPE is predominantly red.

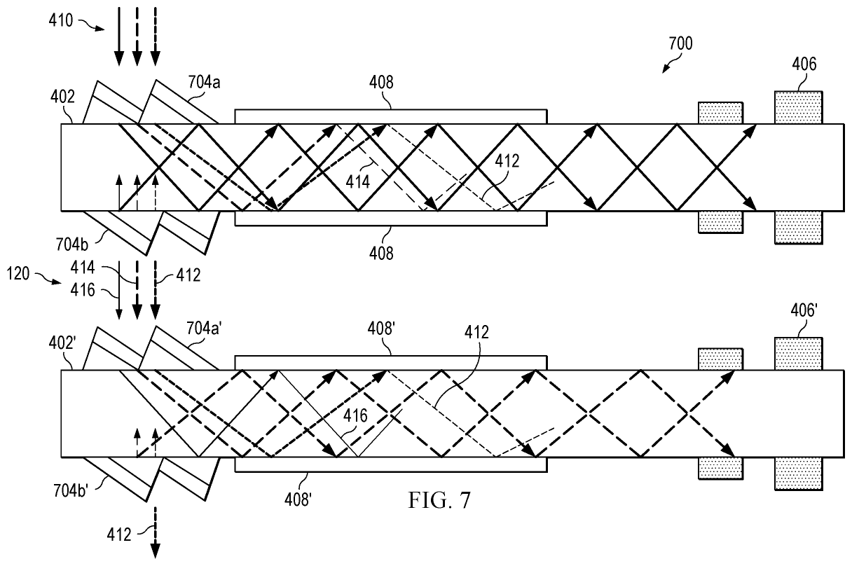

FIG. 7 shows a cross section of eyepiece 700 with color-selective waveguides 402, 402′. Waveguide 402 has two sided ICG 704 with transmissive side 704a and reflective side 704b. Transmissive side 704a is on the user side. Color-absorbing regions 408 between ICG 404 and CPE 406 on surfaces of waveguide 402 are thin films of dispensed or imprinted dye resin formed over imprinted regions 708a.

RGB light 410 enters waveguide 402 through transmissive side 704a of ICG 704 and is totally reflected as it travels from ICG 704 to CPE 406 in waveguide 402. When waveguide 402 is a blue waveguide, regions 408 are formed of a dye resin that absorbs green and red light. Red light 412 and green light 414 are absorbed by regions 408 before the light outcouples, and light that is predominantly blue exits waveguide 402 through CPE 406. Red light 412, green light 414, and attenuated blue light 416 exit waveguide 402 through reflective side 704b of ICG 704, travel through gap 120, and enter waveguide 402′ through transmissive side 704a′ of ICG 704′.

Light that enters transmissive side 704a′ of ICG 704′ is totally reflected as it travels from ICG 704′ to CPE 706′ through waveguide 402′. When waveguide 402′ is a green waveguide, regions 408′ are composed of a dye resin that absorbs red and blue light. Red light 412 and blue light 414 are absorbed by regions 408′, and light that is predominantly green exits waveguide 402′ from CPE 406′. Red light 412, and attenuated green and blue light 414 and 416, if present, exit waveguide 402′ through reflective side 704b′ of ICG 704′. Light that exits waveguide 402′ through reflective side 704b′ of ICG 704′ can travel through a second gap to a third waveguide (not shown) with regions that absorb green and blue light, such that light exiting the third waveguide through a third CPE is predominantly red.

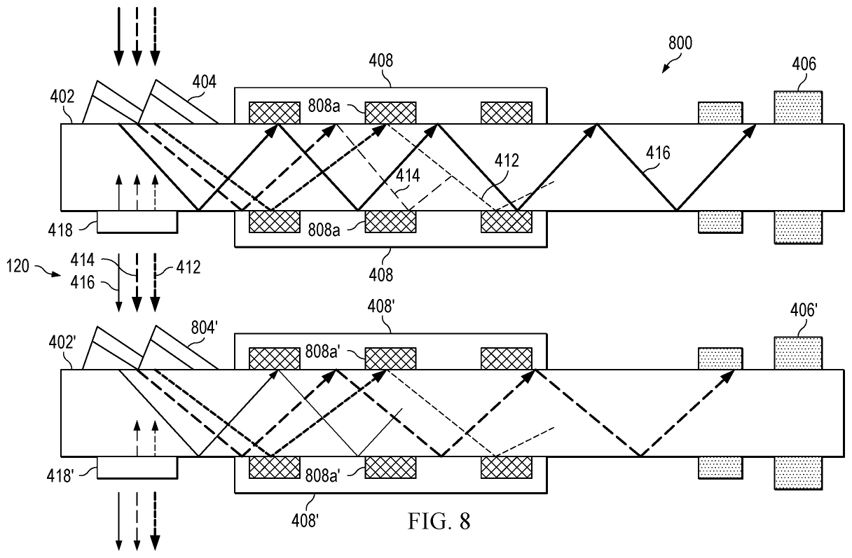

FIG. 8 shows a cross section of eyepiece 800 with color-selective waveguides 402, 402′. Waveguide 402 has inline ICG 404 on the user side (one-side transmissive) and CPE 406. RGB light 410 enters waveguide 402 through ICG 404 and is totally reflected as it travels from ICG 404 to CPE 406 in waveguide 402. When waveguide 402 is a blue waveguide, color-absorbing regions 408 formed of a dye resin that absorbs green and red light. As depicted, regions 408 are formed over output couplers (OC) having imprinted nanofeatures 808a with a green, red, yellow, or orange pitch for extracting green and red light along waveguide 402. Nanofeatures 808a can be color filter nanostructures, such as gratings (for selectivity of polarized light), nanoholes, nanopillars, and the like with different critical dimensions (e.g., diameter, height, width, pitch, etc.) formed by imprinting resin loaded with metal-containing nanoparticles (e.g., aluminum or silver nanoparticles). A high surface to volume ratio of the imprinted features increases color extraction by nanofeatures 808a. In some embodiments, nanofeatures 808a can be composed of a color-absorbing dye resin, such that dispensed color-absorbing regions 408 are optional.

Red light 412 and green light 414 are absorbed by regions 408 before the light outcouples, and light that is predominantly blue exits waveguide 402 through CPE 406. Red light 412, green light 414, and attenuated blue light 416 exit waveguide 402 through anti-reflective layer 418, travel through gap 120, and enter waveguide 402′ through ICG 804′. Anti-reflective layer 418 can be composed of material selected to absorb light of a specific wavelength or wavelength range.

Light that enters ICG 804′ is totally reflected as it travels from ICG 804′ to CPE 406′ through waveguide 402′. When waveguide 402′ is a green waveguide, regions 408′ are formed of a dye resin that absorbs red and blue light. As depicted, regions 408′ are formed over OC having imprinted nanofeatures 808a′ with a low blue or deep red pitch for extracting red and blue light along waveguide 402′. Nanofeatures 408a′ can be color filter nanostructures, such as gratings (for selectivity of polarized light), nanoholes, nanopillars, or a combination thereof, formed from resin loaded with metal-containing nanoparticles (e.g., aluminum or silver nanoparticles). A high surface to volume ratio of the imprinted features increases extraction of light by nanofeatures 408a′. In some embodiments, nanofeatures 808a′ can be composed of a color-absorbing dye resin, such that dispensed color-absorbing regions 408′ are optional.

Light that exits waveguide 402′ through anti-reflective layer 418′ can travel through a second gap to a third waveguide (not shown) with regions that absorb green and blue light, such that light exiting the third waveguide through a third CPE is predominantly red.

Waveguides in the waveguide systems depicted in FIGS. 4-8 can have a variety of dimensions and can be composed of a variety of glasses or polymers. Various ICG and CPE designs can be implemented in the waveguide systems depicted in FIGS. 4-8. Eyepiece (waveguide stack) thicknesses are typically in a range of 300 m to 1 mm, and eyepiece lengths and widths are typically between 20 mm and 60 mm. The waveguide substrates can be composed of high index amorphous glass (e.g., containing TiO₂, ZrO₂, ZnO, La, SiO₂, etc.), synthetic inorganic material (e.g. LiTaO₃, LiNbO₃, SiC) with a refractive index between 1.45 and 2.7. Polymer waveguide substrates can have a refractive index between 1.5 and 1.8 (e.g., polycarbonate, polyimide, and higher index sulfur-containing polymers).

The color-absorbing regions in the waveguides depicted in FIGS. 4-8 can have a selected shape (e.g., round or rectangular), size (e.g., 100 μm² to 10 mm²), thickness (e.g., 100 nm to 100 μm), and color (e.g., red, green, or blue). The color-absorbing regions can have a uniform thickness or can be patterned (e.g., to increase surface to volume ratio). The patterns can include gratings, holes, pillars, etc. that increase surface to volume ratio at the interface at which light is interacting. In one example, a surface exposed to light with nanofeatures having a pitch of 100 nm, a height of 100 nm, and a width of 50 nm has twice the surface area of a blank (unpatterned) surface. A thickness of color-absorbing films can be adjusted by controlling a volume of the curable resin to be imprinted. In one example, a film having a thickness of less than 500 nm can be fabricated by dispensing color-absorbing resin through single or multi-point inkjet printhead, thereby increasing the accuracy and reducing the volume of color-absorbing resin dispensed. Gaps between waveguides are typically between 20 μm and 100 μm. In some embodiments, gaps can be less than 20 μm (e.g., around 5 μm).

Although FIGS. 4-8 are described with respect a blue waveguide and a green waveguide, with incident light traveling through the blue waveguide to the green waveguide (i.e., the blue waveguide on the user side), in other embodiments, waveguides in the waveguide systems disclosed herein can be positioned in any order with respect to the incident light (e.g., GBR, GRB, BRG, RGB, BGR). In other embodiments, waveguide systems of FIGS. 4-8 can have a multiplicity of waveguides of a multiplicity of colors not limited to RGB. In addition, if the incident light is, for example, transverse-electric or transverse-magnetic, color filters, such as those described with respect to FIGS. 5 and 6, may be omitted.

### Examples

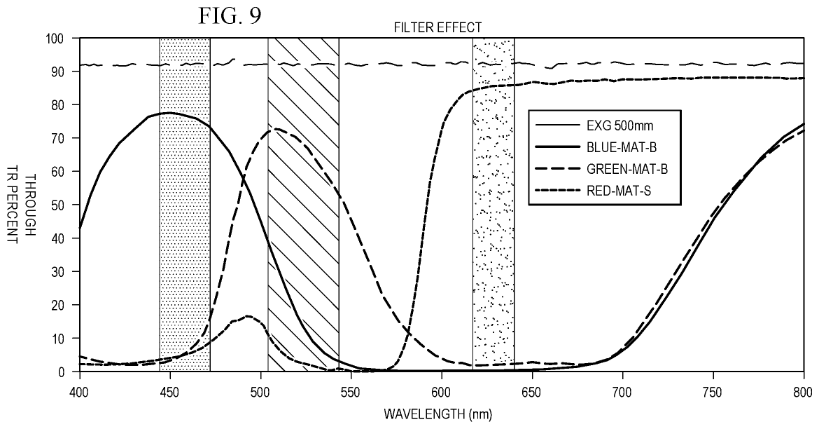

FIG. 9 is a plot showing transmittance as a function of wavelength for colored pigments pressure applied with volatile solvents by spreading over glass control substrates such as CORNING EAGLE XG 300 (EXG 300 μm) to yield colored films. The blue (left), green (middle), and red (right) colors on the plot result from absorption of visible (VIS) light by dyes (e.g., Rhodamine B, Tartarzine) used in colored inks. Resists of any color (e.g., wavelength absorption or transmission spectra) can be prepared by selection of an appropriate dye or pigment.

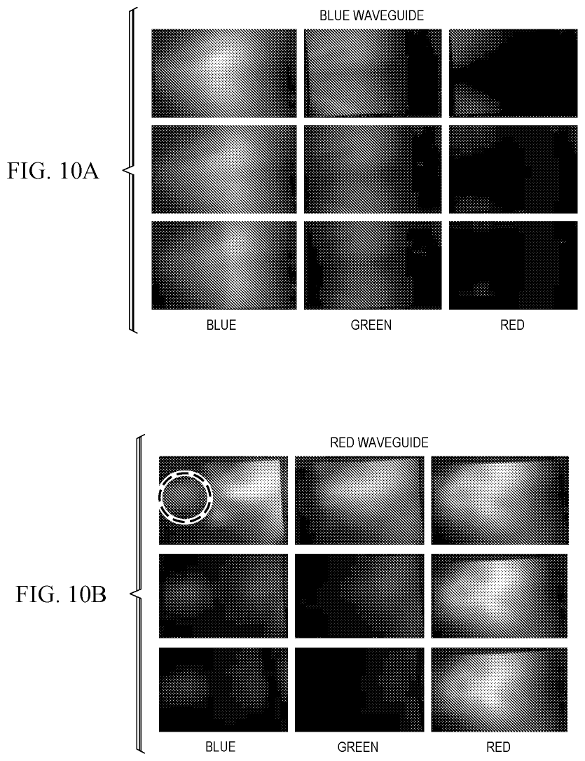

These colored films have been applied to waveguide eyepieces to demonstrate the use of such films in helping specific light propagate through the eyepieces. The films depicted in FIGS. 10A and 10B have a thickness of about 500 nm to about 1 μm as tested. Virtual images in FIGS. 10A and 10B have a 70° field of view (FoV) from blue and red waveguides by incoupling all three colors and having a blue and red absorbing region (1 mm width and 3 mm length) between the IC and the CPE.

FIG. 10A shows optical (autofocus) images for a blue eyepiece, where blue color-absorbing regions were applied between the IC and the CPE. From left to right, the columns show blue, green, and red input (non-polarized light, reticle projector, RGB at 1 mA through a red ICG, and metal) through a waveguide eyepiece meant for blue color. The columns from left to right show RGB color image projection in the IC and camera positioned in front of the eyebox positon of the CPE. The rows from top to bottom represent a waveguide without no absorbing layer, with one absorbing layer, and with an absorbing layer on both sides. In this case, red and green light, when injected into the IC, were not able to couple out of the CPE into the user's FoV.

FIG. 10B shows optical (autofocus) images for a red eyepiece, where red color-absorbing regions were applied between the IC and the CPE. From left to right, the columns show blue, green, and red input (non-polarized light, reticle projector, RGB at 1 mA through a red ICG, and metal) through the red eyepiece. From top to bottom, the rows refer to a first imprint, a second imprint with a red color-absorbing region world side (top inset), and a third imprint with a red color-absorbing region world side and eye side (bottom inset). The refractive index of the imprint resist was in a range of 1.5 to 1.75 (e.g., 1.65 at a wavelength of 530 nm). In this case, blue and green light, when injected into the IC, were not able to couple out of the CPE into the user's FoV.

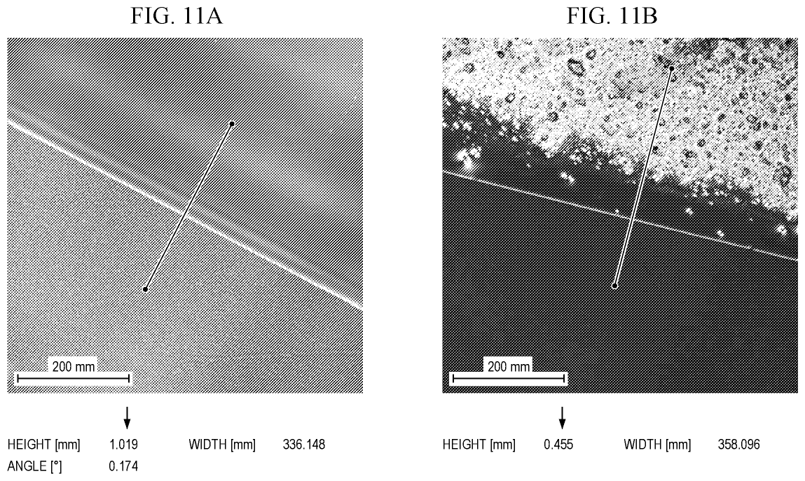

FIGS. 11A and 11B show thicknesses of color-absorbing regions applied to the EXG 300 μm substrates to obtain the images shown in FIGS. 10A and 10B, respectively. The thickness of the color-absorbing region in FIG. 11A is about 1 μm, and the thickness of the color-absorbing region in FIG. 11B is about 0.5 μm.

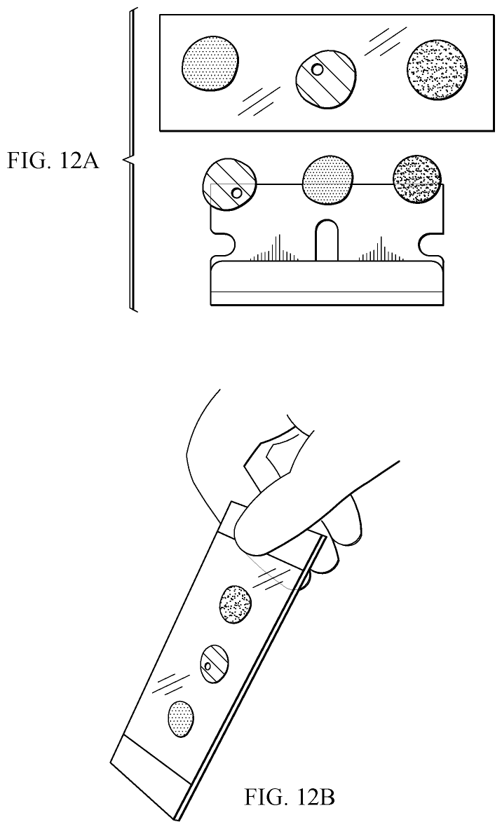

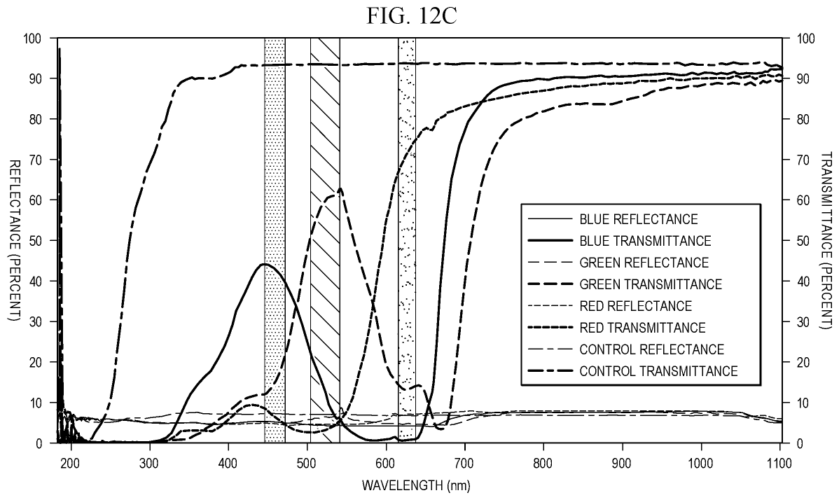

FIGS. 12A and 12B show red, green, and blue color-absorbing films of color-absorbing resin on a clear glass slide. To make the resin, dye or pigment was premixed with solvent and resin, and a photoinitiator was added to yield the UV curable resin. The UV curable resin was molded in a selected size and shape (e.g., discs having a diameter of about 20 μm) that was subsequently cured with UV light. FIG. 12C shows transmittance of the color-absorbing films.

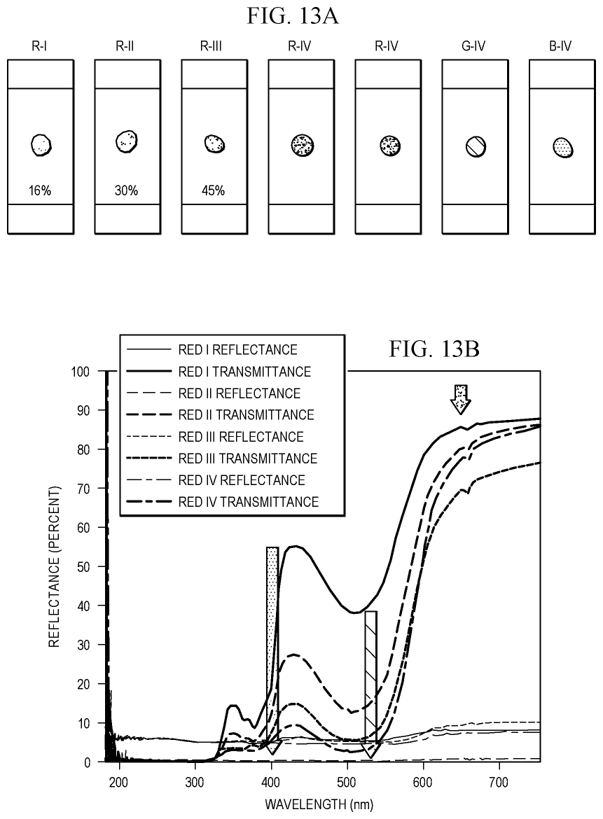

FIG. 13A shows cured color-absorbing films with different concentrations of dye or pigment (wt % loading). FIG. 13B shows transmittance of the color-absorbing films. The magnitude of color absorption or transmission is directly dependent on the concentration of dye or pigment loading (wt % or vol %) with respect to the base UV curable resin.

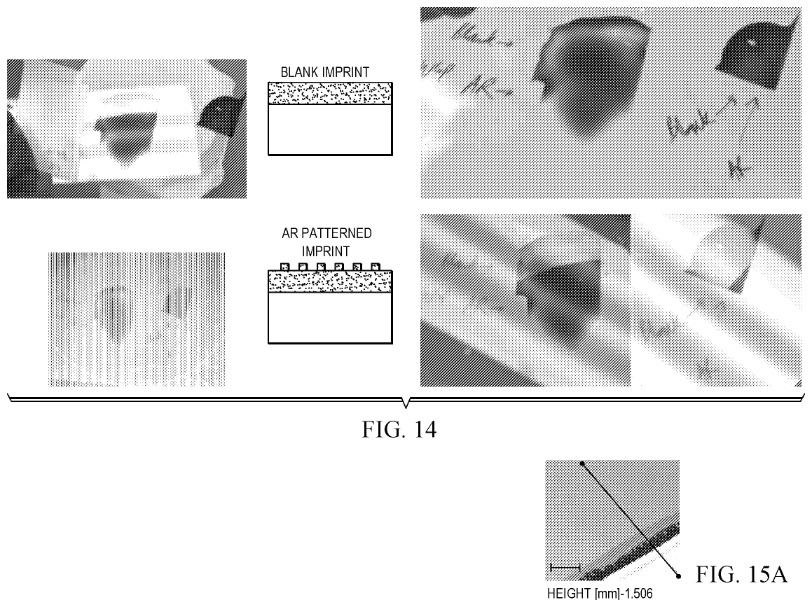

A red colored curable resin was prepared and imprinted with a polycarbonate based flexible coated resist template (CRT). After repeated imprints using volumes 1000× times larger than inkjetted drop volumes, no trace of red coloring was found on the surface of the CRT, as shown in FIG. 14. The CRT was free of residual colored resin and suitable for another imprint, keeping the imprint residue build-up free. Also shown are blank and anti-reflective patterned red color-absorbing film over a glass wafer, demonstrating efficiency of the anti-reflective pattern.

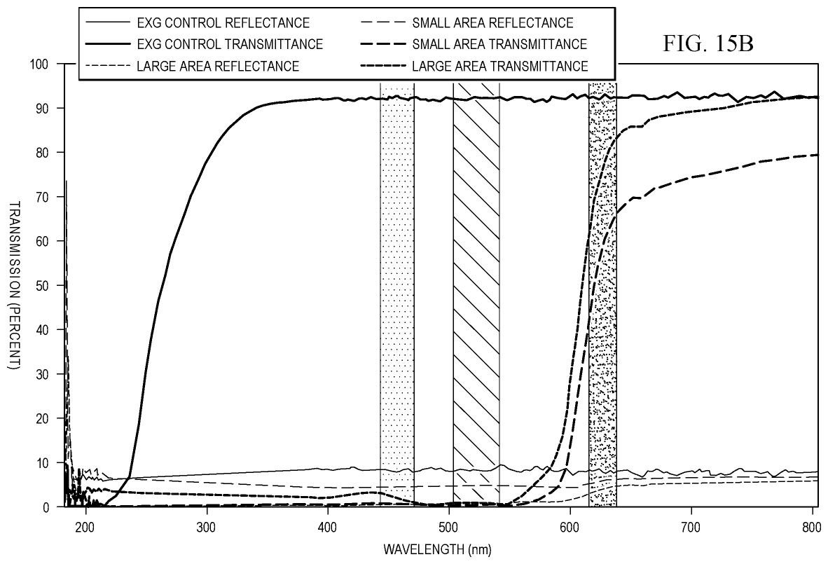

FIG. 15A shows a color-absorbing film with a thickness of about 1 μm to 1.5 μm prepared as described with respect to FIG. 14. FIG. 15B shows transmission of patterned versus blank red colored imprinted film described with respect to FIG. 14. A high transmission of red versus green and blue over an EXG wafer was observed, with nominal transmittance of 92% as the baseline.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

1. An eyepiece comprising:
an optical waveguide;
a transmissive input coupler at a first end of the optical waveguide;
an output coupler at a second end of the optical waveguide; and
a color-absorbing region along a portion of the optical waveguide between the transmissive input coupler and the output coupler, wherein the transmissive input coupler is configured to couple incident visible light to the optical waveguide, and the color-absorbing region is polymeric and configured to absorb a component of the visible light as the visible light propagates through the optical waveguide.

2. The eyepiece of claim 1, wherein an exterior surface of the color-absorbing region defines features comprising protrusions, recessions, or both.

3. The eyepiece of claim 2, wherein the features are nanofeatures.

4. The eyepiece of claim 2, wherein the features define a pattern, and the pattern is a grating.

5. (canceled)

6. The eyepiece of claim 2, wherein the features comprise nanopillars.

7. The eyepiece of claim 2, wherein the features comprise cylindrical recessions.

8. The eyepiece of claim 1, wherein an exterior surface of the color-absorbing region is convex.

9. The eyepiece of claim 1, wherein an exterior surface of the color-absorbing region is planar, and a thickness of the color-absorbing region increases linearly from a first region to a second region.

10. (canceled)

11. (canceled)

12. The eyepiece of claim 1, further comprising a polymeric antireflective layer opposite the input coupler.

13. The eyepiece of claim 12, wherein the polymeric antireflective layer comprises nanopatterned features on an exterior of the optical waveguide.

14. The eyepiece of claim 12, wherein the polymeric antireflective layer is configured to absorb a component of visible light transmitted through the waveguide from the input coupler to the polymeric antireflective layer.

15. The eyepiece of claim 1, wherein the optical waveguide is configured to totally reflect the visible light as the visible light propagates through the optical waveguide.

16. (canceled)

17. The eyepiece of claim 1, wherein the component of visible light comprises red light and green light, and blue light that propagates through the optical waveguide exits the optical waveguide through the output coupler.

18. The eyepiece of claim 1, wherein the transmissive input coupler is an inline input coupler.

19. The eyepiece of claim 1, wherein the output coupler is a combined pupil expander.

20. (canceled)

21. The eyepiece of claim 1, further comprising an additional optical waveguide optically coupled to the optical waveguide, wherein the eyepiece defines a gap between the optical waveguide and the additional optical waveguide.

22. The eyepiece of claim 1, further comprising an additional optical waveguide optically coupled to the optical waveguide, wherein the eyepiece comprises an additional transmissive input coupler at a first end of the additional optical waveguide and an additional output coupler at a second end of the additional optical waveguide.

23. The eyepiece of claim 1, further comprising an additional optical waveguide optically coupled to the optical waveguide, wherein the eyepiece comprises an additional reflective input coupler at a first end of the additional optical waveguide and an additional output coupler at a second end of the additional waveguide.

24. The eyepiece of claim 22, wherein the additional input coupler is configured to couple visible light that passes through an antireflective layer to the additional optical waveguide.

25. The eyepiece of claim 22, further comprising an additional polymeric color-absorbing region along a portion of the additional waveguide between the additional transmissive input coupler and the additional output coupler, wherein the additional transmissive input coupler is configured to couple visible light that passes through an antireflective layer to the additional optical waveguide, and the additional color-absorbing region is configured to absorb an additional component of visible light as the visible light propagates through the optical waveguide.

26.-73. (canceled)
